(19) United States
(12) Patent Application Publication
(10) Pub. No.: US 2025/0341766 A1
(43) Pub. Date: Nov. 6, 2025

(54) AMETROPIA-INDEPENDENT DISPLAY

(71) Applicant: Infineon Technologies AG, Neubiberg (DE)

(72) Inventors: Thomas THURNER, Graz (AT); Boris KIRILLOV, Gratwein-Straßengel (AT)

(21) Appl. No.: 18/652,635

(22) Filed: May 1, 2024

(51) Int. Cl. G03B 21/14; G02B 26/08; G02B 27/01; G02B 27/10; G02F 1/1335; H04N 9/31; H04N 13/363

(52) U.S. Cl. CPC G03B 21/142; G02B 27/0172; G02B 27/104; G02F 1/1335; H04N 9/3129; H04N 13/363; G02B 26/0833

(57) ABSTRACT

An image projection system includes a picture generation unit and a controller. The picture generation unit includes a plurality of monochromatic transmitters configured to transmit light beams corresponding to an image projection plane located at a virtual distance; combining optics configured to combine the light beams into a combined light beam and couple the combined light beam into a combined transmission path; and an ametropia-corrective lens having a configuration corresponding to the virtual distance. The ametropia-corrective lens is configured to receive the combined light beam and transmit the combined light beam further along on the combined transmission path such that the combined light beam renders an image perceived at the image projection plane. The controller is configured to receive ametropia diagnostic information corresponding to an ametropia of an eye, and adjust the configuration of the ametropia-corrective lens in order to adjust the virtual distance of the image projection plane.

### BACKGROUND

Refractive error, sometimes called ametropia, is a problem with focusing light accurately on a retina of an eye due to a shape of the eye and/or a cornea of the eye. In other words, a refractive error may occur when a refractive power of the eye does not match a length of the eye. As a result, an image is focused away from a central part of the retina, instead of directly on it, and appears blurry and/or out-of-focus. Some common types of refractive error include near-sightedness, far-sightedness, astigmatism, and presbyopia. Refractive errors may be corrected with eyeglasses, contact lenses, and/or surgery.

### SUMMARY

In some implementations, an image projection system includes a first picture generation unit comprising: a plurality of first monochromatic transmitters configured to transmit first light beams corresponding to a first image projection plane for a first eye, wherein the first image projection plane is located at a first virtual distance; first combining optics configured to combine the first light beams into a first combined light beam and couple the first combined light beam into a first combined transmission path; and a first ametropia-corrective lens having a first configuration arranged on the first combined transmission path, wherein the first configuration corresponds to the first virtual distance, wherein the first ametropia-corrective lens is configured to receive the first combined light beam and transmit the first combined light beam further along on the first combined transmission path such that the first combined light beam renders a first image perceived at the first image projection plane; and a controller configured to receive first ametropia diagnostic information corresponding to the first eye, and adjust the first configuration of the first ametropia-corrective lens on the first combined transmission path in order to adjust the first virtual distance of the first image projection plane.

In some implementations, an image projection system includes a first picture generation unit configured to generate a first light beam corresponding to a first stereo image to be perceived by a first eye at a first image projection plane located at a first virtual distance; a second picture generation unit configured to generate a second light beam corresponding to a second stereo image to be perceived by a second eye at a second image projection plane located at a second virtual distance; a waveguide substrate comprising: an input area configured to couple the first light beam and the second light beam into the waveguide substrate, and an output area configured to couple out a plurality of first light beam replicas of the first light beam from the waveguide substrate at a plurality of first output locations, respectively, and couple out a plurality of second light beam replicas of the second light beam from the waveguide substrate at a plurality of second output locations, respectively; and a liquid crystal (LC) panel arranged over the output area of the waveguide substrate, wherein the LC panel is configured to selectively permit a first light beam replica of the plurality of first light beam replicas to pass to a first eyebox of the first eye, and selectively block at least one remaining first light beam replica of the plurality of first light beam replicas, and wherein the LC panel is configured to selectively permit a second light beam replica of the plurality of second light beam replicas to pass to a second eyebox of the second eye, and selectively block at least one remaining second light beam replica of the plurality of second light beam replicas.

### BRIEF DESCRIPTION OF THE DRAWINGS

Implementations are described herein making reference to the appended drawings.

FIG. 1A shows an image projection system according to one or more implementations.

FIG. 1B shows a portion of an image projection system according to one or more implementations.

FIG. 1C shows a portion of an image projection system according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view, rather than in detail, in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually interchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling (e.g., any connection or coupling without additional intervening elements) may also be implemented by an indirect connection or coupling (e.g., a connection or coupling with one or more additional intervening elements, or vice versa) as long as the general purpose of the connection or coupling (e.g., to transmit a certain kind of signal or to transmit a certain kind of information) is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, a signal with an approximate signal value may practically have a signal value within 5% of the approximate signal value.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

Display screens, such as screens used for electronic readers, smartphones, and tablets, typically cannot compensate for ametropia. Thus, when a user has an ametropic condition, reading and viewing digital content on a digital device require suitable corrective devices, such as glasses or contact lenses, in order to view clear images of the digital content. Moreover, display screens cannot compensate for different types or different degrees of ametropic conditions that may be present at different eyes (e.g., left eye and right eye) of a user. Moreover, display screens cannot compensate for different types or different degrees of ametropic conditions for all users.

Some implementations are directed to an image projection system of an electronic display that compensates for ametropia of a user. Thus, the image projection system may be used to provide digital content that can be properly seen as a sharp image by a user without use of a corrective device, such as glasses or contact lenses. The image projection system may project an image of the digital content at a virtual distance that differs from an actual distance that exists between the user and the electronic display in order to compensate for the ametropia. The virtual distance may be adjusted in order to compensate for one of more ametropic conditions that are specific to the user. For example, for far-sighted people, the image projection system may project an image at a virtual image distance further away than the actual distance to the electronic display. Alternatively, for near-sighted people, the image projection system may project an image at a virtual image distance that is closer than the actual distance to the electronic display. In addition, the image projection system may generate right-eye images and left-eye images at different virtual distances in order to compensate for one of more ametropic conditions that are specific to each eye of the user. The image projection system may be configured to produce stereoscopic images (e.g., with left eyebox and right eyebox separation for two stereo images) with ametropia-corrected images for each eye. Furthermore, the image projection system may be implemented in three-dimensional (3D) display technologies, including holographic displays, with ametropia-corrected images.

The image projection system may compensate for one of more ametropic conditions based on ametropia diagnostic information corresponding to the user. The ametropia diagnostic information may include medical diagnostic information, such as a corrective vision prescription, input by the user and/or calibration information obtained by the image projection system during a vision test/assessment. Thus, the image projection system may compensate for one or more causes of ametropia that may be specific to the user without a need for additional corrective devices, such as glasses or contact lenses. In other words, the image projection system may enable to view digital content (e.g., ametropia-corrected digital content) from the electronic display without using any additional corrective device.

The image projection system may include one or more picture generation units (e.g., one or more light engines) configured to produce ametropia-corrected images to be projected into a user's line-of-sight by delivery optics. The one or more picture generation units may use laser beam scanning (LBS), digital light processing (DLP), liquid crystal on silicon (LCoS), light emitting diode (LED), or organic light-emitting diode (OLED) technologies for producing the ametropia-corrected images.

The delivery optics may be a display screen that receives the ametropia-corrected images from the one or more picture generation units and delivers the ametropia-corrected images into the user line of sight. The delivery optics may include a waveguide or any other delivery technology that can fulfill requirements to deliver seamless, high-quality digital content to the user. In some implementations, a waveguide may be configured to expand a size of the projected image by expanding a width of the light beams used for generating the projected image.

The image projection system may be configured to provide binocular vision to project ametropia-corrected images into both eyes of the user. For example, stereoscopic imaging may be used to create an illusion of depth by projecting two slightly offset images separately to each eye of the user. For example, the two slightly offset images (e.g., two stereo images) may be of a same scene or a same object but with an illusion of being projected from slightly different angles or perspectives. In other words, the two stereo images may be combined to create a stereoscopic image that has the illusion of depth. Generating the two stereo images should be performed in a synchronized manner in order for the user to properly perceive a coherent image having the illusion of depth. Thus, the image projection system may generate ametropia-corrected stereo images that may be combined to produce an ametropia-corrected stereoscopic image. The image projection system may include components that are duplicated for each eye. For example, separate scanners, light sources, drivers, and processing components may be provided in duplicate to produce separate stereo images.

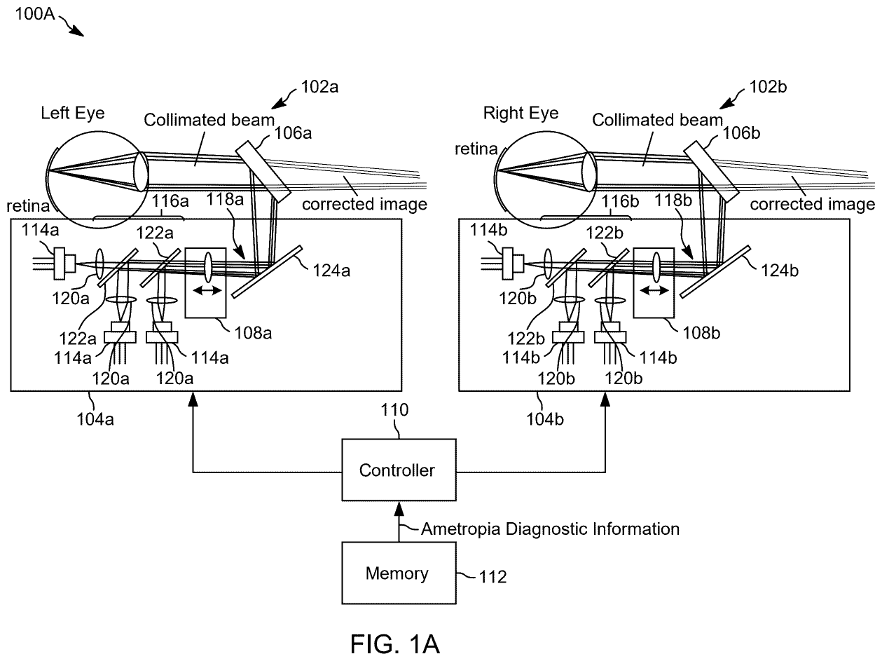

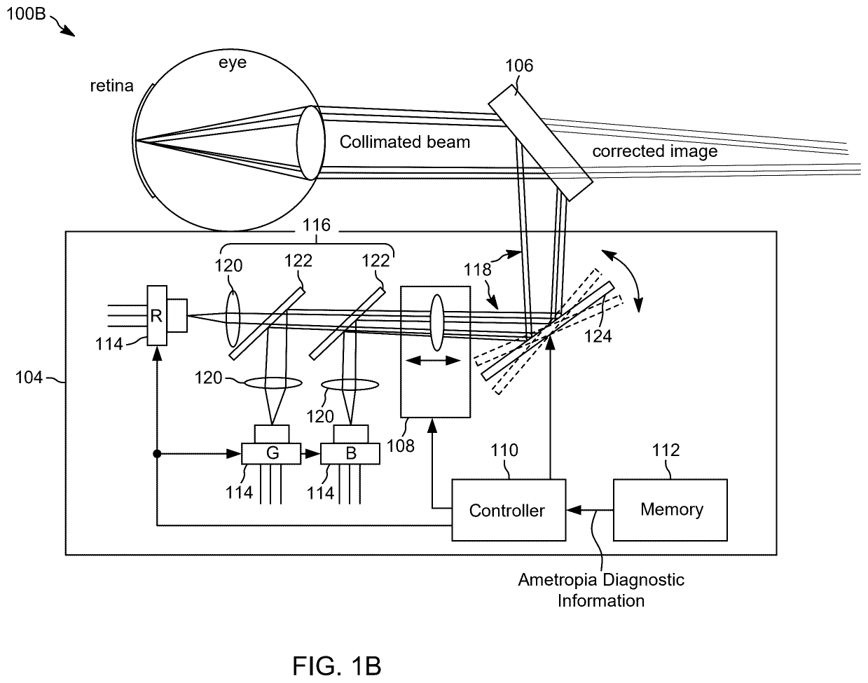

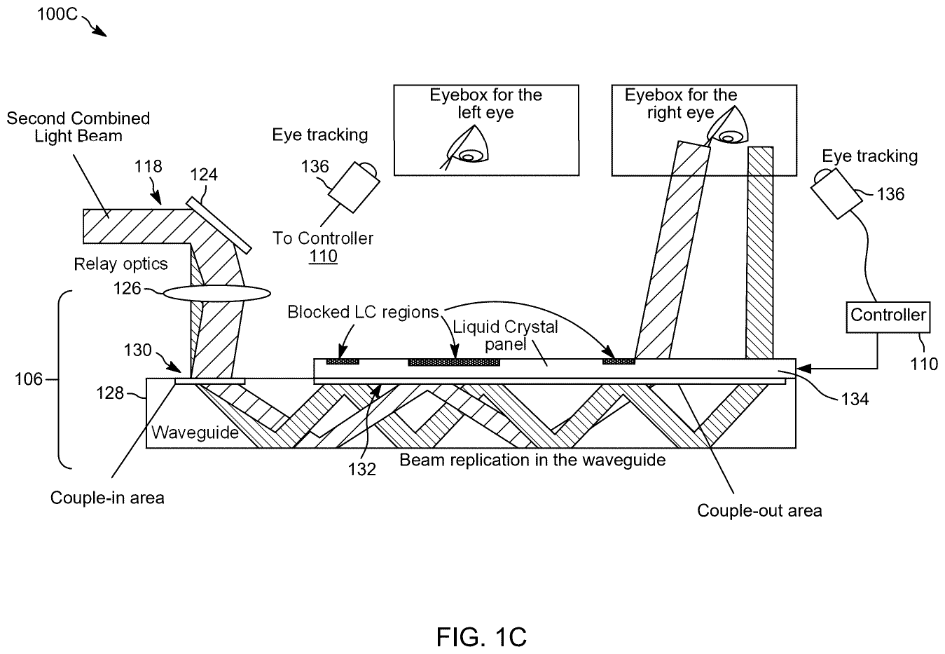

FIG. 1A shows an image projection system 100A according to one or more implementations. The image projection system 100A may be a binocular image projection system that is configured to project separate images (e.g., left eye and right eye images) for a left eye and a right eye of a user. Thus, the image projection system 100A may include a first set of display components 102a dedicated to the left eye and a second set of display components 102b dedicated to the right eye. The first set of display components 102a and the second set of display components 102b may be duplicates of each other.

The first set of display components 102a may include a first picture generation unit 104a and first delivery optics 106a. The first picture generation unit 104a may include one or more first optical ametropia-corrective components (e.g., a first ametropia-corrective lens 108a) that may be configured correct or otherwise compensate for an ametropia of the left eye based on first ametropia diagnostic information corresponding to the left eye. The second set of display components 102b may include a second picture generation unit 104b and second delivery optics 106b. The second picture generation unit 104b may include one or more second optical ametropia-corrective components (e.g., a second ametropia-corrective lens 108b) that may be configured correct or otherwise compensate for an ametropia of the right eye based on second ametropia diagnostic information corresponding to the right eye. Thus, a picture generation unit may be provided for each eye, for example, for projecting stereoscopic images comprising a left-eye stereo image and a right-eye stereo image.

In addition, the image projection system 100A may include a controller 110 and a memory device 112. The memory device 112 may be configured to store the first ametropia diagnostic information and the second ametropia diagnostic information specific for each user. The controller 110 may be configured to access the first ametropia diagnostic information and the second ametropia diagnostic information, adjust a configuration of the one or more first optical ametropia-corrective components based on the first ametropia diagnostic information, and adjust a configuration of the one or more second optical ametropia-corrective components based on the second ametropia diagnostic information.

The controller 110 may also control light generating components (e.g., light sources) and scanning components (e.g., scanning mirrors) of first picture generation unit 104a and the second picture generation unit 104b based on image information. For example, the controller 110 may control pulse timings of one or more red, green, or blue light sources for generating red-green-blue (RGB) projections. In addition, the controller 110 may control the scanning components to generate a scanning pattern for each eye. Thus, the controller 110 may control an actuation of the scanning components, including scanning speed (or scanning frequency), scanning angle, and scanning trajectory. The controller 110 may control the pulse timings of one or more red, green, or blue light sources to generate combined light pulses, such as RGB light pulses, that track a scanning pattern.

The first picture generation unit 104a may include a first RGB light module that includes a plurality of first monochromatic transmitters 114a configured to transmit first light beams corresponding to a first image projection plane for the left eye. Each first monochromatic transmitter 114a may transmit a different color of monochromatic light. The first image projection plane may be located at a first virtual distance.

The first picture generation unit 104a may further include first combining optics 116a configured to combine the first light beams into a first combined light beam and couple the first combined light beam into a first combined transmission path 118a. Each first combined light beam may be transmitted as a light pulse that may be representative of an image pixel of the first image. Each first combined light beam may comprise any combination of a red light pulse, a green light pulse, and/or a blue light pulse emitted simultaneously, including one, two, or three colors in combination at controlled intensities according to the desired pixel hue of a respective image pixel. Accordingly, a first combined light beam may be referred to as a pixel light pulse.

The first combining optics 116a may include a first plurality of collimation lenses 120a and a first plurality of dichroic mirrors 122a. Each of the first plurality of collimation lenses 120a may receive first light beams from a different one of the first plurality of monochromatic transmitters 114a to generate collimated light beams to be projected onto the left eye. The first plurality of dichroic mirrors 122a are used to couple respective collimated light beams into the first combined transmission path 118a such that light from each of the first monochromatic transmitters 114a is combined into a first combined light beam. The first plurality of dichroic mirrors 122a may be configured to direct the first light beams as collimated light beams at the first ametropia-corrective lens 108a that is arranged on the first combined transmission path 118a.

The first ametropia-corrective lens 108a may have a first configuration arranged on the first combined transmission path 118a. The first configuration may correspond to the first virtual distance. For example, the first virtual distance may be changed by changing the first configuration. The first ametropia-corrective lens 108a may receive the first combined light beam and transmit the first combined light beam further along on the first combined transmission path 118a such that the first combined light beam renders a first image perceived at the first image projection plane.

The first picture generation unit 104a may further include a scanner 124a arranged on the first combined transmission path 118a. The scanner may receive the first combined light beam from the first ametropia-corrective lens 108a, and steer the first combined light beam according to a scanning pattern to render the first image onto the left eye. The scanner 124a may be a microelectromechanical system (MEMS) mirror.

A MEMS mirror is a mechanical moving mirror (e.g., a MEMS micro-mirror) integrated on a semiconductor chip (not shown). The MEMS mirror may be suspended by mechanical springs (e.g., torsion bars) or flexures and is configured to rotate about two axes, for example, an x-axis to perform horizontal scanning and a y-axis (e.g., orthogonal to the x-axis) to perform vertical scanning. Using two scanning axes, the MEMS mirror is able to perform scanning in two-dimensions (2D) and may be used for raster or Lissajous scanning operations.

In some implementations, the MEMS mirror may be a resonator (e.g., a resonant MEMS mirror) configured to oscillate “side-to-side” about each scanning axis such that the light reflected from the MEMS mirror oscillates back and forth in a corresponding scanning direction (e.g., a horizontal scanning direction or a vertical scanning direction). A scanning period or an oscillation period is defined, for example, by one complete oscillation from a first edge of a field-of-view (e.g., first side) to a second edge of the field-of-view (e.g., second side) and then back again to the first edge. A mirror period of a MEMS mirror may correspond to a scanning period.

Thus, the field-of-view is scanned in both scanning directions by changing the angle Ox and Oy of the MEMS mirror on its respective scanning axes. A particular scanning pattern may be realized by independently configuring an amplitude range (e.g., an angular range of motion) and a driving frequency with respect to a rotation about each axis. In addition, a shape of a driving waveform of the driving signal used to drive the MEMS mirror about each scanning axis may be independently configured to further define the scanning pattern. For example, the driving waveforms may be sinusoidal for both scanning axes, or one may be sinusoidal and the other may be saw-toothed. The field-of-view may correspond to an eyebox in which a targeted eye is located.

Accordingly, the scanner 124a, arranged on the first combined transmission path 118a, may be used to steer the first combined light beam (e.g., RGB light) received from the first ametropia-corrective lens 108a according to the scanning pattern to render images perceived at the first image projection plane onto the retina of the left eye. The scanner 124a may direct the first combined light beam further along the first combined transmission path 118a toward the first delivery optics 106a, which then directs the first combined light beam at the left eye for rendering images thereon.

The first delivery optics 106a may direct the first combined light beam onto the left eye such that the first image is perceived by the left eye at the first image projection plane. The first delivery optics 106a may include a waveguide substrate configured to receive the first combined light beam at a waveguide input and output the first combined light beam at a waveguide output that corresponds to the left eye. In some implementations, the first delivery optics 106a may include an LC panel arranged over the waveguide substrate.

The controller 110 may receive the first ametropia diagnostic information corresponding to the left eye, and adjust the first configuration of the first ametropia-corrective lens 108a on the first combined transmission path 118a in order to adjust the first virtual distance of the first image projection plane. For example, the first configuration may correspond to a position of the first ametropia-corrective lens 108a on the first combined transmission path 118a. The controller 110 may adjust the first configuration of the first ametropia-corrective lens 108a by adjusting the position of the first ametropia-corrective lens 108a along the first combined transmission path 118a. In other words, the first ametropia-corrective lens 108a may be moved along the first combined transmission path 118a to be close to or further from the first combining optics 116a.

The first ametropia diagnostic information may correspond to an ametropia of the left eye. The controller 110 may adjust the first configuration of the first ametropia-corrective lens 108a on the first combined transmission path 118a such that the first combined light beam is projected onto a retina of the left eye. In other words, the controller 110 may regulate the first virtual distance based on the first ametropia diagnostic information to compensate for the ametropia of the left eye. As a result, the first configuration may be adjusted to compensate for the ametropia of the left eye such that the first image is sharp and clear without the use of additional corrective devices, such as glasses or contact lenses.

The second picture generation unit 104b may be similar to the first picture generation unit 104a, with the exception that the second picture generation unit 104b may be configured to compensate for an ametropia of the right eye. Thus, the second picture generation unit 104b may include a second RGB light module that includes a plurality of second monochromatic transmitters 114b configured to transmit second light beams corresponding to a second image projection plane for the right eye. Each second monochromatic transmitter 114b may transmit a different color of monochromatic light. The second image projection plane may be located at a second virtual distance.

The second picture generation unit 104b may further include second combining optics 116b configured to combine the second light beams into a second combined light beam and couple the second combined light beam into a second combined transmission path 118b. Each second combined light beam may be transmitted as a light pulse that may be representative of an image pixel of the second image. Each second combined light beam may comprise any combination of a red light pulse, a green light pulse, and/or a blue light pulse emitted simultaneously, including one, two, or three colors in combination at controlled intensities according to the desired pixel hue of a respective image pixel. Accordingly, a second combined light beam may be referred to as a pixel light pulse.

The second combining optics 116b may include a second plurality of collimation lenses 120b and a second plurality of dichroic mirrors 122b. Each of the second plurality of collimation lenses 120b may receive second light beams from a different one of the second plurality of monochromatic transmitters 114b to generate collimated light beams to be projected onto the right eye. The second plurality of dichroic mirrors 122b are used to couple respective collimated light beams into the second combined transmission path 118b such that light from each of the second monochromatic transmitters 114b is combined into a second combined light beam. The second plurality of dichroic mirrors 122b may be configured to direct the second light beams as collimated light beams at the second ametropia-corrective lens 108b that is arranged on the second combined transmission path 118b.

The second ametropia-corrective lens 108b may have a second configuration arranged on the second combined transmission path 118b. The second configuration may correspond to the second virtual distance. For example, the second virtual distance may be changed by changing the second configuration. The second ametropia-corrective lens 108b may receive the second combined light beam and transmit the second combined light beam further along on the second combined transmission path 118b such that the second combined light beam renders a second image perceived at the second image projection plane.

The second picture generation unit 104b may further include a scanner 124b arranged on the second combined transmission path 118b. The scanner may receive the second combined light beam from the second ametropia-corrective lens 108b, and steer the second combined light beam according to a scanning pattern to render the second image onto the right eye. The scanner 124b may be a MEMS mirror.

Accordingly, the scanner 124b, arranged on the second combined transmission path 118b, may be used to steer the second combined light beam (e.g., RGB light) received from the second ametropia-corrective lens 108b according to the scanning pattern to render images perceived at the second image projection plane onto the retina of the right eye. The scanner 124b may direct the second combined light beam further along the second combined transmission path 118b toward the second delivery optics 106b, which then directs the second combined light beam at the right eye for rendering images thereon.

The second delivery optics 106b may direct the second combined light beam onto the right eye such that the second image is perceived by the right eye at the second image projection plane. The second delivery optics 106b may include a waveguide substrate configured to receive the second combined light beam at a waveguide input and output the second combined light beam at a waveguide output that corresponds to right eye. In some implementations, the second delivery optics 106b may include an LC panel arranged over the waveguide substrate.

In some implementations, the first set of display components 102a and the second set of display components 102b may share a same delivery optics. In other words, the first delivery optics 106a and the second delivery optics 106b may be combined into a same delivery optics. For example, the first set of display components 102a and the second set of display components 102b may share a same waveguide. Thus, the first combined light beam and the second combined light beam may be coupled into and out of the same waveguide.

The controller 110 may receive the second ametropia diagnostic information corresponding to the right eye, and adjust the second configuration of the second ametropia-corrective lens 108b on the second combined transmission path 118b in order to adjust the second virtual distance of the second image projection plane. For example, the second configuration may correspond to a position of the second ametropia-corrective lens 108b on the second combined transmission path 118b. The controller 110 may adjust the second configuration of the second ametropia-corrective lens 108b by adjusting the position of the second ametropia-corrective lens 108b along the second combined transmission path 118b. In other words, the second ametropia-corrective lens 108b may be moved along the second combined transmission path 118b to be close to or further from the second combining optics 116b.

The second ametropia diagnostic information may correspond to an ametropia of the right eye. The controller 110 may adjust the second configuration of the second ametropia-corrective lens 108b on the second combined transmission path 118b such that the second combined light beam is projected onto a retina of the right eye. In other words, the controller 110 may regulate the second virtual distance based on the second ametropia diagnostic information to compensate for the ametropia of the right eye. As a result, the second configuration may be adjusted to compensate for the ametropia of the right eye such that the second image is sharp and clear without the use of additional corrective devices, such as glasses or contact lenses.

In some implementations, the controller 110 may control the first picture generation unit 104a and the second picture generation unit 104b in a time multiplexed manner such that the first combined light beam and the second combined light beam are transmitted in different time slots. For example, the first image may be a first stereo image and the second image may be a second stereo image that, when projected with the first stereo image, produces a stereoscopic image. Pixels of the first stereo image and the second stereo image may be transmitted in time multiplexed manner in different time slots in order to produce the stereoscopic image.

As indicated above, FIG. 1A is provided as an example. Other examples may differ from what is described with regard to FIG. 1A. In practice, the image projection system 100A may include additional components, fewer components, different components, or differently arranged components than those shown in FIG. 1A without deviating from the disclosure provided above.

FIG. 1B shows a portion 100B of an image projection system according to one or more implementations. The image projection system of FIG. 1B may correspond to the image projection system 100A described in connection with FIG. 1A. For example, the portion 100B may correspond to an implementation of the first set of display components 102a or the second set of display components 102b. Thus, FIG. 1B is provided to more clearly illustrate a set of display components 102 of the image projection system 100A.

The set of display components 102 may include a picture generation unit 104 and delivery optics 106. The picture generation unit 104 may include an ametropia-corrective lens 108, a controller 110, a memory device 112, a plurality of monochromatic transmitters 114, combining optics 116, a combined transmission path 118, a plurality of collimation lenses 120, plurality of dichroic mirrors 122, and a scanner 124, as similarly described in connection with FIG. 1A.

In some implementations, the first set of display components 102a and the second set of display components 102b may share the delivery optics 106. For example, the delivery optics 106 may include a single waveguide that is configured to receive the first combined light beam and the second combined light beam, couple out the first combined light beam out toward the left eye, and couple out the second combined light beam toward the right eye.

As indicated above, FIG. 1B is provided as an example. Other examples may differ from what is described with regard to FIG. 1B.

FIG. 1C shows a portion 100C of an image projection system according to one or more implementations. The image projection system of FIG. 1C may correspond to an implementation of the image projection system 100A described in connection with FIG. 1A. For example, the portion 100C may correspond to the delivery optics 106 that is shared by the first set of display components 102a and the second set of display components 102b. The delivery optics 106 may include relay optics 126, a waveguide substrate 128 having an input area 130 and an output area 132, and an LC panel 134.

The relay optics 126 may receive a combined light beam (e.g., an RGB light beam) from the scanner 124, and direct the combined light beam into the input area 130 of the waveguide substrate 128. In some implementations, the input area 130 may include a couple-in grating configured to couple the combined light beam into the waveguide substrate 128. The coupled-in light travels along the waveguide substrate 128 via internal refraction toward the output area 132. In some implementations, the output area 132 may include a couple-out grating configured to couple light out of the waveguide substrate 128. The output area 132 may be configured to deliver the combined light beam to a user's eye in accordance with a scanning pattern implemented by the scanner 124.

As the combined light beam propagates through the waveguide substrate 128, portions of the combined light beam may be coupled out by the output area 132. Some portions of the combined light beam may reflect back inward by the output area 132, thereby propagating further along the waveguide substrate 128, and then be reflected back at the output area 132 where they are coupled out. As a result, the combined light beam may be output by the output area 132 in multiple instances or in multiple replications along a width of the output area 132 (e.g., along a propagation dimension that corresponds to direction in which the light travels in the waveguide substrate 128). Thus, the output area 132 may be configured to couple out a plurality of light beam replicas of the combined light beam from the waveguide substrate 128 at a plurality of output locations. The combined light beam may be intended for a targeted eye (e.g., the left eye or the right eye).

However, as a result of the plurality of light beam replicas being produced from the combined light beam, some of the plurality of light beam replicas may be directed to an undesired location, including to an eyebox that corresponds to an unintended eye. In other words, some of the plurality of output locations may be associated with different transmit directions that do not correspond to an eyebox of the targeted eye. The LC panel 134 may be arranged over the output area 132 of the waveguide substrate 128, and may be configured to selectively block one or more of the plurality of output locations to prevent one or more of the plurality of light beam replicas from being delivered to an unintended location, while selectively permitting one or more of the plurality of output locations to pass one or more of the plurality of light beam replicas to a desired location, such as to the eyebox of the targeted eye.

Since the delivery optics 106 may be shared by the first set of display components 102a and the second set of display components 102b, the delivery optics 106 may receive the first combined light beam corresponding to a first stereo image (e.g., a first ametropia-corrected stereo image) to be perceived by the left eye at the first image projection plane located at the first virtual distance. Additionally, the delivery optics 106 may receive the second combined light beam corresponding to a second stereo image (e.g., a second ametropia-corrected stereo image) to be perceived by the right eye at the second image projection plane located at the second virtual distance. Delivery of pixels of the first stereo image and the second stereo image may be time multiplexed to produce a stereoscopic image. The delivery optics 106 may receive the first combined light beam and the second combined light beam in a time multiplexed manner based on a multiplexing scheme implemented by the controller 110.

The input area 130 may couple the first combined light beam and the second combined light beam into the waveguide substrate 128. The output area 132 may couple out a plurality of first combined light beam replicas of the first combined light beam from the waveguide substrate 128 at a plurality of first output locations, respectively, and couple out a plurality of second combined light beam replicas of the second combined light beam from the waveguide substrate 128 at a plurality of second output locations, respectively. The LC panel 134 may be configured by the controller 110 to selectively permit a first combined light beam replica of the plurality of first combined light beam replicas to pass to an eyebox of the left eye (e.g., to a left eyebox), and selectively block at least one remaining first combined light beam replica of the plurality of first combined light beam replicas from being delivered into free space. In addition, the LC panel 134 may be configured to selectively permit a second combined light beam replica of the plurality of second combined light beam replicas to pass to an eyebox of the right eye (e.g., to a right eyebox), and selectively block at least one remaining second combined light beam replica of the plurality of second combined light beam replicas from being delivered into free space. Since the delivery optics 106 may receive the first combined light beam and the second combined light beam in a time multiplexed manner in different time slots, the controller 110 may change a configuration of blocked regions of the LC panel 134 for each time slot such that the blocked regions of the LC panel 134 are configured appropriately to prevent undesired beam replicas from being delivered to undesired locations, while allowing desired beam replicas to pass in a desired direction corresponding to a desired location (e.g., to a desired eyebox).

The controller 110 may receive first position information corresponding to a location of the left eye, and receive second position information corresponding to a location of the right eye. For example, the portion 100C of an image projection system may include one or more eye tracking camera 136 configured to track the location of the left eye to generate the first position information, and track the location of the right eye to generate the second position information.

For a transmission of the first combined light beam, the controller 110 may configure the LC panel 134, based on the first position information, to be optically transparent over a first output location corresponding to the first combined light beam replica such that the first combined light beam replica is permitted to pass to the left eyebox. Additionally, the controller 110 may configure the LC panel 134, based on the first position information, to be optically nontransparent over each remaining first output location of the plurality of first output locations such that each remaining first combined light beam replica of the plurality of first combined light beam replicas is blocked. A projection of each remaining first combined light beam replica may correspond to locations outside the left eyebox.

For a transmission of the second combined light beam, the controller 110 may configure the LC panel 134, based on the second position information, to be optically transparent over a second output location corresponding to the second combined light beam replica such that the second combined light beam replica is permitted to pass to the right eyebox. Additionally, the controller 110 may configure the LC panel 134, based on the second position information, to be optically nontransparent over each remaining second output location of the plurality of second output locations such that each remaining second combined light beam replica of the plurality of second combined light beam replicas is blocked. A projection of each remaining second combined light beam replica may correspond to locations outside the right eyebox.

The controller 110 may reconfigure the LC panel 134 based on the first position information indicating a change in the location of the left eye, and may reconfigure the LC panel 134 based on the second position information indicating a change in the location of the right eye. For example, the controller 110 may reconfigure the LC panel 134 for subsequent first combined light beams and subsequent second combined light beams based on changes to the first position information and the second position information, respectively. In some implementations, the controller 110 may configure or reconfigure the LC panel 134 based on the first position information, and may configure or reconfigure the LC panel 134 based on the second position information in order to generate a privacy screen, from which only the user can view images from the LC panel 134. Thus, the waveguide substrate 128 and the LC panel 134 may form the privacy screen. For example, since the controller 110 may configure the LC panel 134 to project images only into the left and right eyeboxes of the user, which are person-specific, and all remaining combined light beam replicas outside of the left and right eyeboxes may be blocked by the LC panel 134, bystanders can be blocked from viewing images projected from the LC panel 134. The controller 110 may configure the LC panel 134 such that all remaining first light beam replicas of the plurality of first light beam replicas corresponding to locations outside of the first eyebox are blocked. In addition, the controller 110 may configure the LC panel 134 such that all remaining second light beam replicas of the plurality of second light beam replicas corresponding to locations outside of the second eyebox are blocked. Thus, the projected images may be privately viewed by only the user.

The controller 110 may control the first picture generation unit 104a and the second picture generation unit 104b (not illustrated) in a time multiplexed manner such that the first combined light beam and the second combined light beam are transmitted in different time slots. In other words, the controller 110 may configure the LC panel 134 (e.g., blocked LC regions) in the time multiplexed manner such that the LC panel 134 is configured to pass the first combined light beam replica to the left eyebox in a first time slot and pass the second combined light beam replica to the right eyebox in a second time slot that is different from the first time slot.

As indicated above, FIG. 1C is provided as an example. Other examples may differ from what is described with regard to FIG. 1C.

The following provides an overview of some Aspects of the present disclosure:

Aspect 1: An image projection system, comprising: a first picture generation unit comprising: a plurality of first monochromatic transmitters configured to transmit first light beams corresponding to a first image projection plane for a first eye, wherein the first image projection plane is located at a first virtual distance; first combining optics configured to combine the first light beams into a first combined light beam and couple the first combined light beam into a first combined transmission path; and a first ametropia-corrective lens having a first configuration arranged on the first combined transmission path, wherein the first configuration corresponds to the first virtual distance, wherein the first ametropia-corrective lens is configured to receive the first combined light beam and transmit the first combined light beam further along on the first combined transmission path such that the first combined light beam renders a first image perceived at the first image projection plane; and a controller configured to receive first ametropia diagnostic information corresponding to the first eye, and adjust the first configuration of the first ametropia-corrective lens on the first combined transmission path in order to adjust the first virtual distance of the first image projection plane.

Aspect 2: The image projection system of Aspect 1, wherein the first ametropia diagnostic information corresponds to an ametropia of the first eye, and wherein the controller is configured to adjust the first configuration of the first ametropia-corrective lens on the first combined transmission path such that the first combined light beam is projected onto a retina of the first eye.

Aspect 3: The image projection system of any of Aspects 1-2, wherein the first ametropia diagnostic information corresponds to an ametropia of the first eye, and wherein the controller is configured to adjust the first configuration of the first ametropia-corrective lens on the first combined transmission path to compensate for the ametropia of the first eye.

Aspect 4: The image projection system of any of Aspects 1-3, further comprising: delivery optics arranged on the first combined transmission path, wherein the delivery optics is configured to receive the first combined light beam from the first ametropia-corrective lens, and direct the first combined light beam onto the first eye such that the first image is perceived by the first eye at the first image projection plane.

Aspect 5: The image projection system of Aspect 4, wherein the delivery optics includes a waveguide substrate configured to receive the first combined light beam at a waveguide input and output the first combined light beam at a waveguide output that corresponds to first eye.

Aspect 6: The image projection system of any of Aspects 1-5, wherein the first picture generation unit further comprises: a scanner arranged on the first combined transmission path, wherein the scanner is configured to receive the first combined light beam from the first ametropia-corrective lens, and steer the first combined light beam according to a scanning pattern to render the first image onto the first eye.

Aspect 7: The image projection system of any of Aspects 1-6, further comprising: a second picture generation unit comprising: a plurality of second monochromatic transmitters configured to transmit second light beams corresponding to a second image projection plane for a second eye, wherein the second image projection plane is located at a second virtual distance; second combining optics configured to combine the second light beams into a second combined light beam and couple the second combined light beam into a second combined transmission path; and a second ametropia-corrective lens having a second configuration arranged on the second combined transmission path, wherein the second configuration corresponds to the second virtual distance, wherein the second ametropia-corrective lens is configured to receive the second combined light beam and transmit the second combined light beam further along on the second combined transmission path such that the second combined light beam renders a second image perceived at the second image projection plane, wherein the controller is configured to receive second ametropia diagnostic information corresponding to the second eye, and adjust the second configuration of the second ametropia-corrective lens on the second combined transmission path in order to adjust the second virtual distance of the second image projection plane.

Aspect 8: The image projection system of Aspect 7, wherein the first image is a first stereo image and the second image is a second stereo image that, when projected with the first stereo image, produces a stereoscopic image.

Aspect 9: The image projection system of Aspect 7, wherein the first ametropia diagnostic information corresponds to an ametropia of the first eye, wherein the second ametropia diagnostic information corresponds to an ametropia of the second eye, wherein the controller is configured to adjust the first configuration of the first ametropia-corrective lens on the first combined transmission path to compensate for the ametropia of the first eye, and wherein the controller is configured to adjust the second configuration of the second ametropia-corrective lens on the second combined transmission path to compensate for the ametropia of the second eye.

Aspect 10: The image projection system of any of Aspects 1-9, wherein the first configuration corresponds to a position on the first combined transmission path, and wherein the controller is configured to adjust the first configuration of the first ametropia-corrective lens by adjusting the position of the first ametropia-corrective lens along the first combined transmission path.

Aspect 11: An image projection system, comprising: a first picture generation unit configured to generate a first light beam corresponding to a first stereo image to be perceived by a first eye at a first image projection plane located at a first virtual distance; a second picture generation unit configured to generate a second light beam corresponding to a second stereo image to be perceived by a second eye at a second image projection plane located at a second virtual distance; a waveguide substrate comprising: an input area configured to couple the first light beam and the second light beam into the waveguide substrate, and an output area configured to couple out a plurality of first light beam replicas of the first light beam from the waveguide substrate at a plurality of first output locations, respectively, and couple out a plurality of second light beam replicas of the second light beam from the waveguide substrate at a plurality of second output locations, respectively; and a liquid crystal (LC) panel arranged over the output area of the waveguide substrate, wherein the LC panel is configured to selectively permit a first light beam replica of the plurality of first light beam replicas to pass to a first eyebox of the first eye, and selectively block at least one remaining first light beam replica of the plurality of first light beam replicas, and wherein the LC panel is configured to selectively permit a second light beam replica of the plurality of second light beam replicas to pass to a second eyebox of the second eye, and selectively block at least one remaining second light beam replica of the plurality of second light beam replicas.

Aspect 12: The image projection system of Aspect 11, wherein the first stereo image and the second stereo image produce a stereoscopic image.

Aspect 13: The image projection system of any of Aspects 11-12, wherein the first picture generation unit is configured to: receive first ametropia diagnostic information corresponding to an ametropia of the first eye, and regulate the first virtual distance based on the first ametropia diagnostic information to compensate for the ametropia of the first eye, and wherein the second picture generation unit is configured to: receive second ametropia diagnostic information corresponding to an ametropia of the second eye, and regulate the second virtual distance based on the second ametropia diagnostic information to compensate for the ametropia of the second eye.

Aspect 14: The image projection system of any of Aspects 11-13, further comprising: a controller configured to: receive first position information corresponding to a location of the first eye, configure the LC panel, based on the first position information, to be optically transparent over a first output location corresponding to the first light beam replica such that the first light beam replica is permitted to pass to the first eyebox, configure the LC panel, based on the first position information, to be optically nontransparent over each remaining first output location of the plurality of first output locations such that each remaining first light beam replica of the plurality of first light beam replicas is blocked, receive second position information corresponding to a location of the second eye, configure the LC panel, based on the second position information, to be optically transparent over a second output location corresponding to the second light beam replica such that the second light beam replica is permitted to pass to the second eyebox, and configure the LC panel, based on the second position information, to be optically nontransparent over each remaining second output location of the plurality of second output locations such that each remaining second light beam replica of the plurality of second light beam replicas is blocked.

Aspect 15: The image projection system of Aspect 14, wherein the controller is configured to reconfigure the LC panel based on the first position information indicating a change in the location of the first eye, and reconfigure the LC panel based on the second position information indicating a change in the location of the second eye.

Aspect 16: The image projection system of Aspect 14, further comprising: at least one eye tracking camera configured to track the location of the first eye to generate the first position information, and track the location of the second eye to generate the second position information.

Aspect 17: The image projection system of Aspect 14, wherein the controller is configured to control the first picture generation unit and the second picture generation unit in a time multiplexed manner such that the first light beam and the second light beam are transmitted in different time slots.

Aspect 18: The image projection system of Aspect 17, wherein the controller is configured to configure the LC panel in the time multiplexed manner such that the LC panel is configured to pass the first light beam replica and the second light beam replica according to the different time slots.

Aspect 19: The image projection system of any of Aspects 11-18, further comprising: a controller configured to control the first picture generation unit and the second picture generation unit in a time multiplexed manner such that the first light beam and the second light beam are transmitted in different time slots.

Aspect 20: The image projection system of any of Aspects 11-19, further comprising: a controller configured to configure the LC panel in a time multiplexed manner such that the LC panel is configured to pass the first light beam replica to the first eyebox in a first time slot and pass the second light beam replica to the second eyebox in a second time slot that is different from the first time slot.

Aspect 21: The image projection system of any of Aspects 11-20, wherein a projection of the at least one remaining first light beam replica corresponds to a location outside the first eyebox, and wherein a projection of the at least one remaining second light beam replica corresponds to a location outside the second eyebox.

Aspect 22: The image projection system of Aspects 11-20, wherein the waveguide and the LC panel form a privacy screen, wherein the controller is configured to configure the LC panel such that all remaining first light beam replicas of the plurality of first light beam replicas corresponding to locations outside of the first eyebox are blocked, and wherein the controller is configured to configure the LC panel such that all remaining second light beam replicas of the plurality of second light beam replicas corresponding to locations outside of the second eyebox are blocked.

Aspect 23: A system configured to perform one or more operations recited in one or more of Aspects 1-22.

Aspect 24: An apparatus comprising means for performing one or more operations recited in one or more of Aspects 1-22.

Aspect 25: A non-transitory computer-readable medium storing a set of instructions, the set of instructions comprising one or more instructions that, when executed by a device, cause the device to perform one or more operations recited in one or more of Aspects 1-22.

Aspect 26: A computer program product comprising instructions or code for executing one or more operations recited in one or more of Aspects 1-22.

The foregoing disclosure provides illustration and description, but is not intended to be exhaustive or to limit the implementations to the precise form disclosed. Modifications and variations are possible in light of the above disclosure or may be acquired from practice of the implementations.

For example, although implementations described herein relate to MEMS devices with a mirror, it is to be understood that other implementations may include optical devices other than MEMS mirror devices or other MEMS oscillating structures. In addition, although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer, or an electronic circuit.

Some implementations may be described herein in connection with thresholds. As used herein, “satisfying” a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, the term “component” is intended to be broadly construed as hardware, firmware, or a combination of hardware and software. Systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein, refers to any of the foregoing structures or any other structure suitable for implementation of the techniques described herein. Software may be stored on a non-transitory computer-readable medium such that the non-transitory computer readable medium includes program code or a program algorithm stored thereon that, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal, further information. “Signal conditioning,” as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation, and any other processes required to make a signal suitable for processing after conditioning.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a and b, a and c, b and c, and a, b, and c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. An image projection system, comprising:
a first picture generation unit comprising:
a plurality of first monochromatic transmitters configured to transmit first light beams corresponding to a first image projection plane for a first eye, wherein the first image projection plane is located at a first virtual distance;
first combining optics configured to combine the first light beams into a first combined light beam and couple the first combined light beam into a first combined transmission path; and
a first ametropia-corrective lens having a first configuration arranged on the first combined transmission path, wherein the first configuration corresponds to the first virtual distance, wherein the first ametropia-corrective lens is configured to receive the first combined light beam and transmit the first combined light beam further along on the first combined transmission path such that the first combined light beam renders a first image perceived at the first image projection plane; and
a controller configured to receive first ametropia diagnostic information corresponding to the first eye, and adjust the first configuration of the first ametropia-corrective lens on the first combined transmission path in order to adjust the first virtual distance of the first image projection plane.

2. The image projection system of claim 1, wherein the first ametropia diagnostic information corresponds to an ametropia of the first eye, and
wherein the controller is configured to adjust the first configuration of the first ametropia-corrective lens on the first combined transmission path such that the first combined light beam is projected onto a retina of the first eye.

3. The image projection system of claim 1, wherein the first ametropia diagnostic information corresponds to an ametropia of the first eye, and
wherein the controller is configured to adjust the first configuration of the first ametropia-corrective lens on the first combined transmission path to compensate for the ametropia of the first eye.

4. The image projection system of claim 1, further comprising:
delivery optics arranged on the first combined transmission path, wherein the delivery optics is configured to receive the first combined light beam from the first ametropia-corrective lens, and direct the first combined light beam onto the first eye such that the first image is perceived by the first eye at the first image projection plane.

5. The image projection system of claim 4, wherein the delivery optics includes a waveguide substrate configured to receive the first combined light beam at a waveguide input and output the first combined light beam at a waveguide output that corresponds to first eye.

6. The image projection system of claim 1, wherein the first picture generation unit further comprises:
a scanner arranged on the first combined transmission path, wherein the scanner is configured to receive the first combined light beam from the first ametropia-corrective lens, and steer the first combined light beam according to a scanning pattern to render the first image onto the first eye.

7. The image projection system of claim 1, further comprising:
a second picture generation unit comprising:
a plurality of second monochromatic transmitters configured to transmit second light beams corresponding to a second image projection plane for a second eye, wherein the second image projection plane is located at a second virtual distance;
second combining optics configured to combine the second light beams into a second combined light beam and couple the second combined light beam into a second combined transmission path; and
a second ametropia-corrective lens having a second configuration arranged on the second combined transmission path, wherein the second configuration corresponds to the second virtual distance, wherein the second ametropia-corrective lens is configured to receive the second combined light beam and transmit the second combined light beam further along on the second combined transmission path such that the second combined light beam renders a second image perceived at the second image projection plane,
wherein the controller is configured to receive second ametropia diagnostic information corresponding to the second eye, and adjust the second configuration of the second ametropia-corrective lens on the second combined transmission path in order to adjust the second virtual distance of the second image projection plane.

8. The image projection system of claim 7, wherein the first image is a first stereo image and the second image is a second stereo image that, when projected with the first stereo image, produces a stereoscopic image.

9. The image projection system of claim 7, wherein the first ametropia diagnostic information corresponds to an ametropia of the first eye,
wherein the second ametropia diagnostic information corresponds to an ametropia of the second eye,
wherein the controller is configured to adjust the first configuration of the first ametropia-corrective lens on the first combined transmission path to compensate for the ametropia of the first eye, and
wherein the controller is configured to adjust the second configuration of the second ametropia-corrective lens on the second combined transmission path to compensate for the ametropia of the second eye.

10. The image projection system of claim 1, wherein the first configuration corresponds to a position on the first combined transmission path, and
wherein the controller is configured to adjust the first configuration of the first ametropia-corrective lens by adjusting the position of the first ametropia-corrective lens along the first combined transmission path.

11. An image projection system, comprising:
a first picture generation unit configured to generate a first light beam corresponding to a first stereo image to be perceived by a first eye at a first image projection plane located at a first virtual distance;
a second picture generation unit configured to generate a second light beam corresponding to a second stereo image to be perceived by a second eye at a second image projection plane located at a second virtual distance;
a waveguide substrate comprising:
an input area configured to couple the first light beam and the second light beam into the waveguide substrate, and
an output area configured to couple out a plurality of first light beam replicas of the first light beam from the waveguide substrate at a plurality of first output locations, respectively, and couple out a plurality of second light beam replicas of the second light beam from the waveguide substrate at a plurality of second output locations, respectively; and
a liquid crystal (LC) panel arranged over the output area of the waveguide substrate,
wherein the LC panel is configured to selectively permit a first light beam replica of the plurality of first light beam replicas to pass to a first eyebox of the first eye, and selectively block at least one remaining first light beam replica of the plurality of first light beam replicas, and
wherein the LC panel is configured to selectively permit a second light beam replica of the plurality of second light beam replicas to pass to a second eyebox of the second eye, and selectively block at least one remaining second light beam replica of the plurality of second light beam replicas.

12. The image projection system of claim 11, wherein the first stereo image and the second stereo image produce a stereoscopic image.

13. The image projection system of claim 11, wherein the first picture generation unit is configured to:
receive first ametropia diagnostic information corresponding to an ametropia of the first eye, and
regulate the first virtual distance based on the first ametropia diagnostic information to compensate for the ametropia of the first eye, and
wherein the second picture generation unit is configured to:
receive second ametropia diagnostic information corresponding to an ametropia of the second eye, and
regulate the second virtual distance based on the second ametropia diagnostic information to compensate for the ametropia of the second eye.

14. The image projection system of claim 11, further comprising:
a controller configured to:
receive first position information corresponding to a location of the first eye,
configure the LC panel, based on the first position information, to be optically transparent over a first output location corresponding to the first light beam replica such that the first light beam replica is permitted to pass to the first eyebox,
configure the LC panel, based on the first position information, to be optically nontransparent over each remaining first output location of the plurality of first output locations such that each remaining first light beam replica of the plurality of first light beam replicas is blocked,
receive second position information corresponding to a location of the second eye,
configure the LC panel, based on the second position information, to be optically transparent over a second output location corresponding to the second light beam replica such that the second light beam replica is permitted to pass to the second eyebox, and
configure the LC panel, based on the second position information, to be optically nontransparent over each remaining second output location of the plurality of second output locations such that each remaining second light beam replica of the plurality of second light beam replicas is blocked.

15. The image projection system of claim 14, wherein the controller is configured to reconfigure the LC panel based on the first position information indicating a change in the location of the first eye, and reconfigure the LC panel based on the second position information indicating a change in the location of the second eye.

16. The image projection system of claim 14, further comprising:
at least one eye tracking camera configured to track the location of the first eye to generate the first position information, and track the location of the second eye to generate the second position information.

17. The image projection system of claim 14, wherein the controller is configured to control the first picture generation unit and the second picture generation unit in a time multiplexed manner such that the first light beam and the second light beam are transmitted in different time slots.

18. The image projection system of claim 17, wherein the controller is configured to configure the LC panel in the time multiplexed manner such that the LC panel is configured to pass the first light beam replica and the second light beam replica according to the different time slots.

19. The image projection system of claim 11, further comprising:
a controller configured to control the first picture generation unit and the second picture generation unit in a time multiplexed manner such that the first light beam and the second light beam are transmitted in different time slots.

20. The image projection system of claim 11, further comprising:
a controller configured to configure the LC panel in a time multiplexed manner such that the LC panel is configured to pass the first light beam replica to the first eyebox in a first time slot and pass the second light beam replica to the second eyebox in a second time slot that is different from the first time slot.

21. The image projection system of claim 11, wherein a projection of the at least one remaining first light beam replica corresponds to a location outside the first eyebox, and
wherein a projection of the at least one remaining second light beam replica corresponds to a location outside the second eyebox.

22. The image projection system of claim 11, wherein the waveguide and the LC panel form a privacy screen, and
wherein the controller is configured to configure the LC panel such that all remaining first light beam replicas of the plurality of first light beam replicas corresponding to locations outside of the first eyebox are blocked, and
wherein the controller is configured to configure the LC panel such that all remaining second light beam replicas of the plurality of second light beam replicas corresponding to locations outside of the second eyebox are blocked.
